(19) United States
(12) Patent Application Publication
(10) Pub. No.: US 2013/0009969 A1
(43) Pub. Date: Jan. 10, 2013

(54) Methods circuits & systems for wireless transmission of a video signal from a computing platform

(76) Inventors: Netanel Goldberg, Zichron Yaakov (IL); Uri Kanonich, Herzlia (IL)

(21) Appl. No.: 13/067,891

(22) Filed: Jul. 5, 2011

(51) Int. Cl. G06F 13/14; G06F 13/36

(52) U.S. Cl. 345/520; 710/306; 710/305

(57) ABSTRACT

Disclosed are methods, circuits and systems for wireless transmission of a video signal from a computing platform. There is provided a video and/or audio signal source device such as a laptop computer. The video and/or audio signal source device may include a Display Mini Card (DMC) System Connector. The video and/or audio signal source device may include a Mini Card (HMC or FMC) System Connector, and/or a Display Port (DP) connector. There may be provided a Display Mini Card (DMC) or a Mini Card (FMC or HMC) which may include electrical circuits adapted to receive video and/or audio signals from the DMC System Connector or the DP connector of the video and/or audio signal source device. Received video and/or audio signals may be transmitted to a functionally associated video/audio receiver. The electrical circuits of the Display Mini Card (DMC) or the Mini Card (FMC or HMC) may be adapted to transmit a video and/or audio signal using a video link such as WHDI, WIFI DIRECT or WIFI DISPLAY. The Display Mini Card (DMC) or the Mini Card (FMC or HMC) may include additional circuits adapted to perform additional functionality such as Wi-Fi communication.

### FIELD OF THE INVENTION

Some embodiments relate generally to the field of video transmission and, more particularly, to methods, circuits & systems for wireless transmission of a video signal from a computing platform.

### BACKGROUND

Wireless communication has rapidly evolved over the past decades. Even today, when high performance and high bandwidth wireless communication equipment is made available, there is demand for even higher performance at higher data rates, which may be required by more demanding applications.

More mobile devices are being designed to support video content e.g. internet video, BD, HDTV, home HD-Video. Users desire to display video content on a screen or projector at a distance from the video source without connecting wires or external dongles to their mobile devices. Connection of such a display or projector to the video source through cables is generally undesired for aesthetic reasons and/or installation convenience. This trend is becoming more common as flat-screen displays, e.g., plasma, Liquid Crystal Display (LCD) or LED televisions are hung on a wall.

Radio technologies such as WHDI are evolving which will support the higher bandwidths needed to support these video streams from the video source to the display.

Laptop computers typically have one or several expansion interface slots for plugging in additional functionalities (e.g. Wi-Fi) which are not part of the laptop's motherboard. The expansion slots are usually Mini PCI-Express card interfaces.

The DisplayPort interface (DP) is the long term video interface standard for computing devices. Many next generations may only support DP from their native graphics system.

To enable the best user experience, enable the fastest time to market, and to reduce the complexity of product development, a single standard interface from the graphics subsystem was introduced. DP is the most logical interface to accomplish this task. By adding the 24 DisplayPort pins to the standard PCI-Express Half-Mini Card (HMC) interface, a new Display Mini Card (DMC) interface was created. The DMC form-factor requires a new connector to support the additional 24 pins. This new connector is compatible with the existing HMC connector such that a HMC can be inserted and function in a DMC socket.

By adding additional pins to support the full DP interface, future changes to the DP standard will be directly supported by the DMC interface. One such interface is the HDMI emulation mode. This mode provides DRM (digital rights management) support via the current HDMI definitions. Dongles today have support for the HDMI DRM over a wireless link.

Prior to the introduction of the Display Mini Card (DMC) interface, there were several non-standard methods to provide a video interface to a Mini Card connector. These include reuse of existing pins, causing compatibility issues. Other methods use reserved pins which cause compatibility issues as these pins are defined for specific functions.

To avoid these issues additional cables were being used but additional cables increases complexity, requires multiple connections, and introduces multiple points for failure.

There is thus a need in the field of wireless communication for improved methods, circuits and systems for wireless transmission of a video signal from a computing platform (e.g. laptop).

### SUMMARY OF THE INVENTION

The present invention includes methods, circuits and systems for wireless transmission of a video signal from a computing platform.

There may be provided a switching circuit adapted to switch between receiving data over the first bus when in the first transmission mode or over the second bus when in the second transmission mode. Either the first or the second transmission mode may be a video transmission mode (e.g. WHDI, Wi-Fi Direct or Wi-Fi Display).

According to further embodiments, a computing and communications device may include a central processing unit (CPU) adapted to generate data network based data, and further adapted to transmit the data along a first bus, a graphics processing unit (GPU) adapted to generate video data, and further adapted to transmit the data along a second bus, and a transmission block (e.g. peripheral comprising) having: (a) a first bus interface adapted to connect the transmission block to the first bus; (b) a second bus interface adapted to connect the transmission block to the second bus; and (c) wireless transceiver circuitry adapted to transmit data network based data received by said peripheral over the first bus according to a first mode and to transmit video data received by said peripheral over the second bus according to a second mode. The computing and communications device may include control logic adapted to select a transmission mode from either the first transmission mode or the second transmission mode. The control logic may be further adapted to select a transmission mode corresponding to data received over the busses. The transmission block may further include a switching circuit adapted to switch between receiving data over the first bus when in the first transmission mode or over the second bus when in the second transmission mode. The video data may be transmitted in a wireless video transmission mode such as WHDI, WIFI Direct and/or WIFI Display.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary setup showing a laptop computer transmitting a wireless video signal (e.g. WHDI) to a display/screen, according to some embodiments of the present invention;

FIG. 2 is an exemplary schematic of a wireless video signal transmitter module/card including a data signal transmission mode, according to some embodiments of the present invention;

FIG. 3A is a functional block diagram of a computing/communications device including a dual mode wireless signal transmitter, according to some embodiments of the present invention;

FIG. 3B is a flowchart including the steps of an exemplary method by which the computing/communications device of FIG. 3A may operate, according to some embodiments of the present invention;

FIG. 4 shows an exemplary schematic of three types of PCI-Express mini cards;

FIG. 5A shows an exemplary schematic of antennas and DMC system connectors for a laptop computer, according to some embodiments of the present invention;

FIG. 5B shows an exemplary schematic of a DMC connected to one antenna, according to some embodiments of the present invention;

FIG. 5C shows an exemplary schematic of a DMC plugged into a laptop's DMC system connector, according to some embodiments of the present invention. The DMC includes a first electrical circuit connected to one antenna and further includes a second electrical circuit;

FIG. 5D shows an exemplary schematic of a DMC plugged into a laptop's DMC system connector, according to some embodiments of the present invention. The DMC includes a first electrical circuit connected to one antenna and further includes a second electrical circuit connected to a second antenna;

FIG. 5E shows an exemplary schematic of a DMC including first and second electrical circuits connected to one antenna, according to some embodiments of the present invention;

FIG. 5F shows an exemplary schematic of a DMC including first and second electrical circuits having an additional shared electrical circuit connected to one antenna, according to some embodiments of the present invention;

FIG. 6 shows an exemplary diagram of time domain multiplexing (TDM) of two transmitting circuits, according to some embodiments of the present invention;

FIG. 7A shows an exemplary schematic of antennas, DMC system connectors and a Display Port connector for a source device (e.g. laptop computer), according to some embodiments of the present invention; and

FIG. 7B shows an exemplary schematic of antennas, DMC system connectors and a Display Port connector for a source device (e.g. laptop computer), according to some embodiments of the present invention. A full mini card is attached to a DMC system connector, a Display Port connector and one antenna.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (AN) receivers/transmitters, gaming consoles, video cameras, video recorders, portable media players, cell phones, mobile devices, and/or automobile AN accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional AN, for example, as part of any suitable camera, video camera, and/or AN accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this' respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of AN information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g.; from the Internet.

According to some embodiments of the present invention, there is provided a video and/or audio signal source device such as a laptop computer. According to some embodiments of the present invention, the video and/or audio signal source device may include a Display Mini Card (DMC) System Connector. According to some embodiments of the present invention, the video and/or audio signal source device may include a Mini Card (HMC or FMC) System Connector, and/or a Display Port (DP) connector. According to some embodiments of the present invention, there may be provided a Display Mini Card (DMC) or a Mini Card (FMC or HMC) which may include electrical circuits adapted to receive video and/or audio signals from the DMC System Connector or the DP connector of the video and/or audio signal source device. Received video and/or audio signals may be transmitted to a functionally associated video/audio receiver. According to some embodiments of the present invention, the electrical circuits of the Display Mini Card (DMC) or the Mini Card (FMC or HMC) may be adapted to transmit a video and/or audio signal using WHDI. According to some embodiments of the present invention, the Display Mini Card (DMC) or the Mini Card (FMC or HMC) may include additional circuits adapted to perform additional functionality such as Wi-Fi communication.

According to some embodiments of the present invention, part of the Display Mini Card (DMC) or the Mini Card (FMC or HMC) circuitry may be adapted to be shared and/or used for video and/or audio transmission, in addition to one or more transmission modes (e.g. Wi-Fi). According to some embodiments of the present invention, the Display Mini Card (DMC) or the Mini Card (FMC or HMC) may be connected to one or more functionally associated antennas. According to some embodiments of the present invention, the Display Mini Card (DMC) or the Mini Card (FMC or HMC) may include one or more antennas. According to further embodiments of the present invention, the Display Mini Card (DMC) or the Mini Card (FMC or HMC) may send a video and/or audio signal along one or more antennas for transmission. According to some embodiments of the present invention, the Display Mini Card (DMC) or the Mini Card (FMC or HMC) may also send and/or receive other signals (e.g. Wi-Fi signals) to/from the same antenna for transmission and/or reception.

According to embodiments, there may be provided a peripheral including a first bus interface adapted to connect the peripheral to a first bus on a host device, a second bus interface adapted to connect the peripheral to a second bus on a host device, and wireless transceiver circuitry adapted to transmit data received by said peripheral over the first bus according to a first mode and to transmit data received by said peripheral over the second bus according to a second mode. The peripheral may further comprising control logic adapted to select a transmission mode from either the first transmission mode or the second transmission mode. The control logic may further be adapted to select a transmission mode corresponding to data received over the busses.

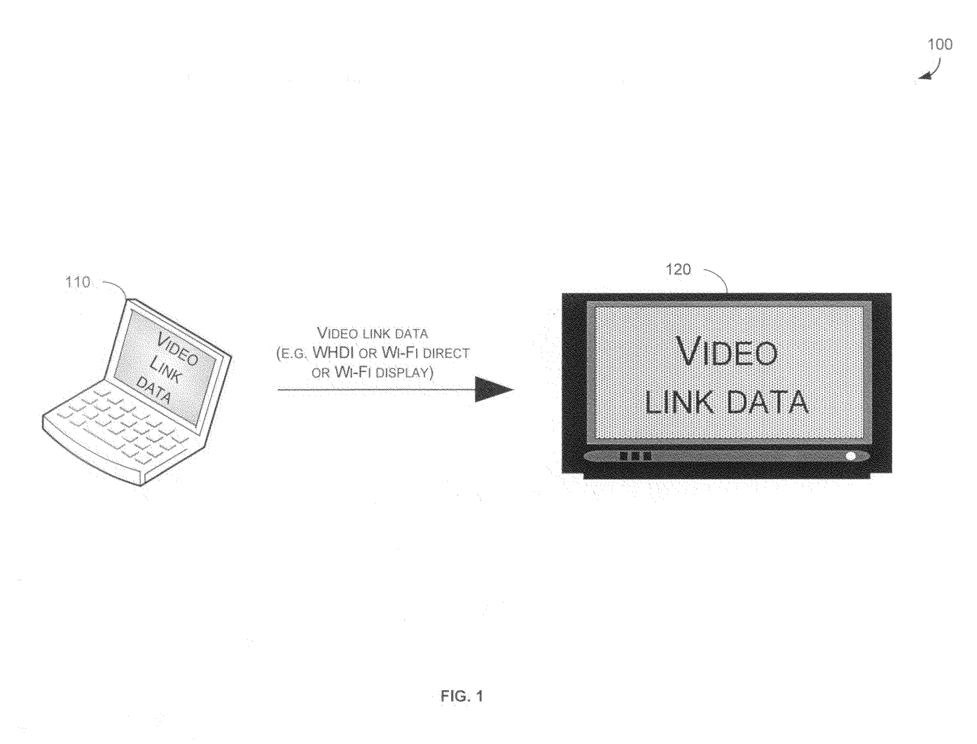

Now turning to FIG. 1, there is shown an exemplary setup (100) showing a laptop computer (110) transmitting a wireless video signal (e.g. WHDI, WIFI DIRECT, WIFI DISPLAY) to a display/screen (120), according to some embodiments of the present invention

According to some embodiments of the present invention, there is provided a video and/or audio source device (e.g. laptop computer 110). According to further embodiments of the present invention, the video and/or audio source device may contain a display (e.g. LCD screen). According to further embodiments of the present invention, a video stream sent to the source device display may be transmitted wirelessly to a video and/or audio sink device.

According to some embodiments of the present invention, the source device may transmit wireless signals in addition to the wireless video transmission. The source device may transmit: local area network (LAN) communication signals, wireless local area network (WLAN) communication signals, wide area network (WAN) communication signals, wireless wide area network (WWAN) communication signals, Wi-Fi signals, cellular network signals and/or Bluetooth signals.

In devices such as laptop computers, there may be a need to transmit a video signal corresponding to a video signal displayed on the device's screen, to another device such as a video projector, LCD, LED or Plasma screen. According to some embodiments of the present invention, a transmitting device operating on battery power may employ a power saving transmission architecture. According to further embodiments of the present invention, the transmitting device may require functionality (e.g. wireless data communication) not integral to a mother board of the transmitting device.

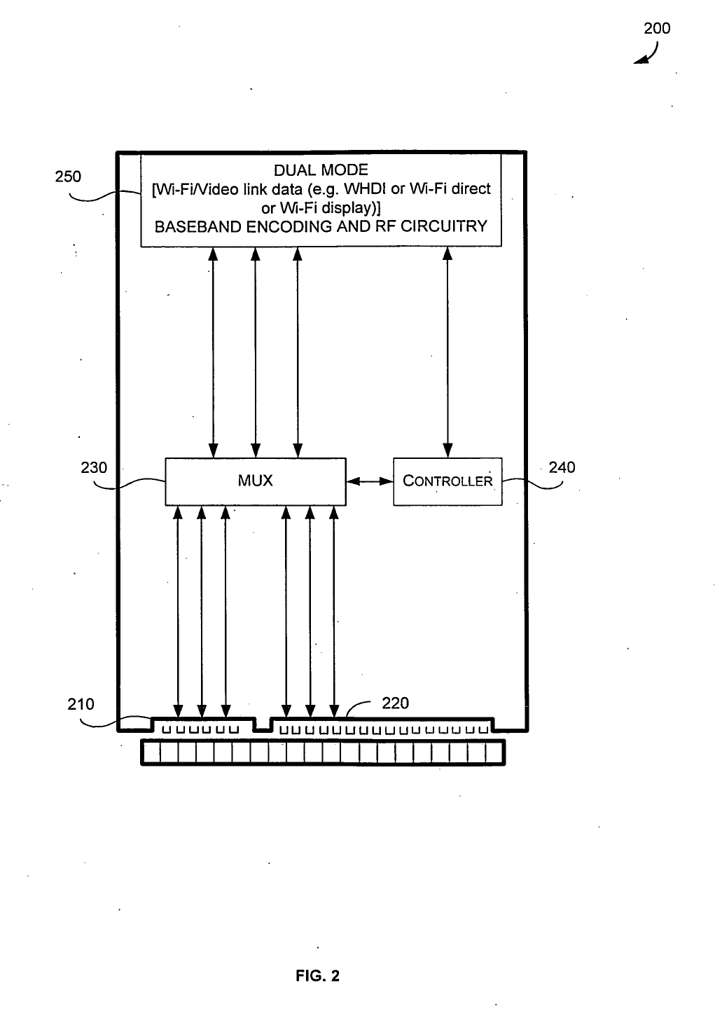

Now turning to FIG. 2, there is shown an exemplary schematic of a wireless video signal transmitter module/card including a data signal transmission mode (200), according to some embodiments of the present invention.

According to some embodiments of the present invention, the wireless video signal transmitter module/card (200) may comprise a multiplexer (MUX 230) for selecting input signals via a video data source connector (210) arid/or via a network data source connector (220). The wireless video signal transmitter module/card (200) may comprise dual mode (e.g. Wi-FiNideo-Link) baseband encoding and RF circuitry (250) for processing selected video data and/or network data for wireless transmission. According to further embodiments of the present invention an integral or otherwise functionally associated controller (240) may control the operation of the MUX and the mode selection of the dual mode baseband encoding and RF circuitry (250).

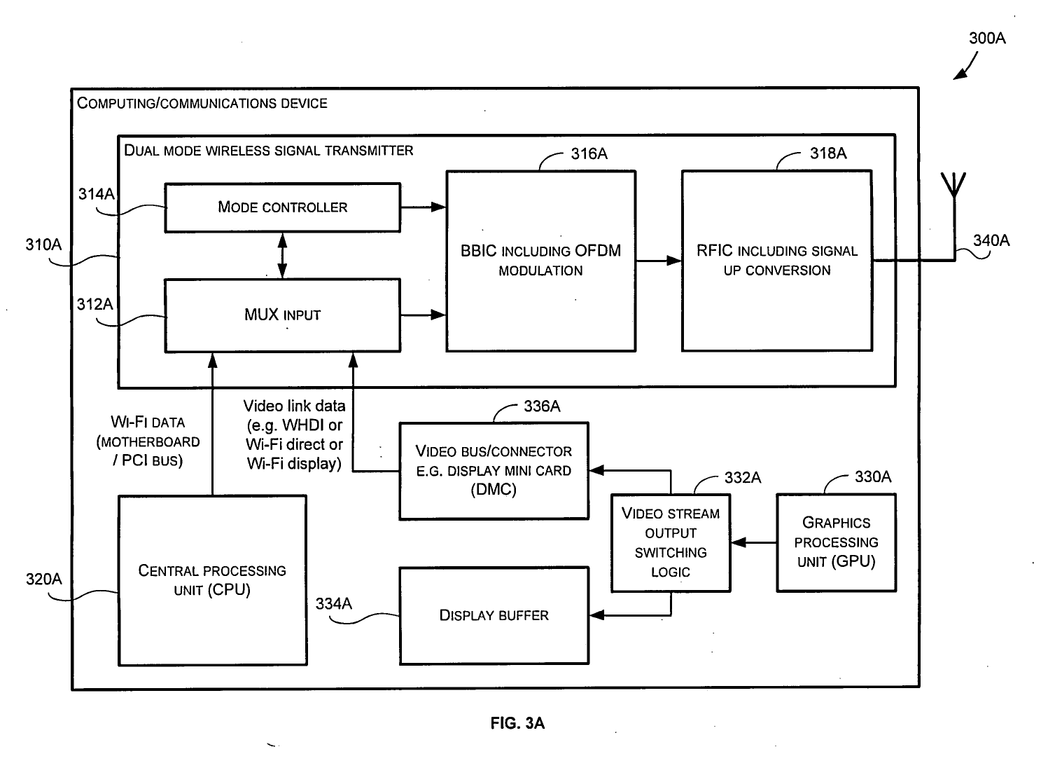

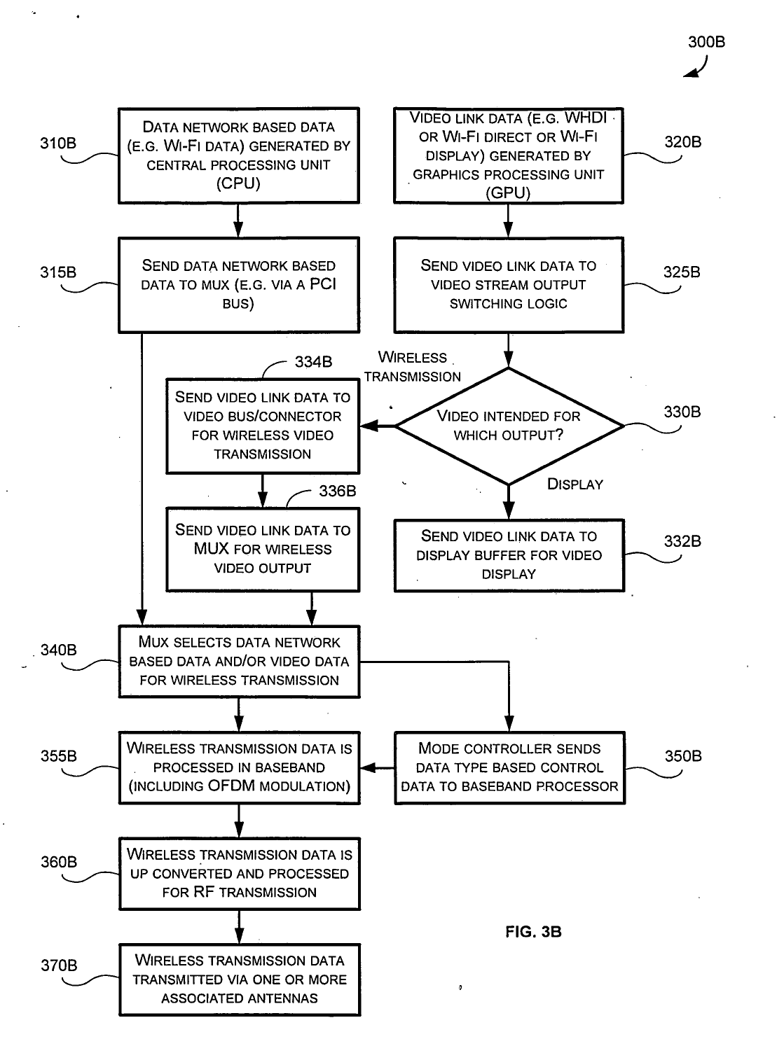

Now turning to FIG. 3A, there is shown a functional block diagram of a computing/communications device (300A) including a dual mode wireless signal transmitter (310A), according to some embodiments of the present invention.

The operation of the computing/communications device (300A) may be described in view of FIG. 3B showing: FIG. 3B—a flowchart (300B) including the steps of an exemplary method by which the computing/communications device (300A) may operate, according to some embodiments of the present invention.

According to some embodiments of the present invention, a computing/communications device (300A) may include a central processing unit (CPU 320A) for processing, calculating and controlling functions and circuitry integral to the device and a graphics processing unit (GPU 330A) for graphics processing and controlling graphical functions and graphics circuitry integral to the device. According to further embodiments of the present invention, the device (300A) may include a video stream output switching logic (332A), a display buffer (334A) and a video bus/connector (336A). The video bus/connector (336A) may be a display mini card (DMC).

According to some embodiments of the present invention, the device (300A) may include a dual mode wireless signal transmitter (310A). The dual mode wireless signal transmitter (310A) may further include a multiplexing input (MUX input 312A), a mode controller (314A), a baseband integrated circuit (BBIC 316A) including orthogonal frequency-division modulation (OFDM) and a radio-frequency integrated circuit (RFIC 318A) including signal up conversion.

According to some embodiments of the present invention, the CPU (320A) may generate (310B) data network based data (e.g. Wi-Fi data). The generated data network based data may be sent (315B) to the MUX input (312A).

According to some embodiments of the present invention, the GPU (330A) may generate (320B) video data and send (325B) the video data to the video stream output switching logic (332A). The video stream output switching logic (332A) may determine (330B) for which output the received video is intended. According to further embodiments of the present invention when the received video is intended for an integral or otherwise functionally associated display, the video data may be sent (332B) to the display buffer (334A) for video display output. According to further embodiments of the present invention when the received video is intended for wireless transmission, the video data may be sent (334B) to the video bus/connector (336A) for wireless video transmission. The video data may be sent (336B) to the MUX input (312A) for wireless video output.

According to some embodiments of the present invention, the MUX input (312A) may select (340B) data network based data and/or video data for wireless transmission. The data network based data and/or video data may be sent to the BBIC (316A) for baseband processing including OFDM modulation (355B). According to further embodiments of the present invention, the mode controller (314A) may send data type based control data (350B) to the BBIC (316A). According to some embodiments of the present invention, baseband processed data may be up converted and processed for RF transmission (360B) by the RFIC (318A). According to further embodiments of the present invention, all wireless transmission data may be transmitted (370B) via one or more integral or otherwise functionally associated antennas (340A).

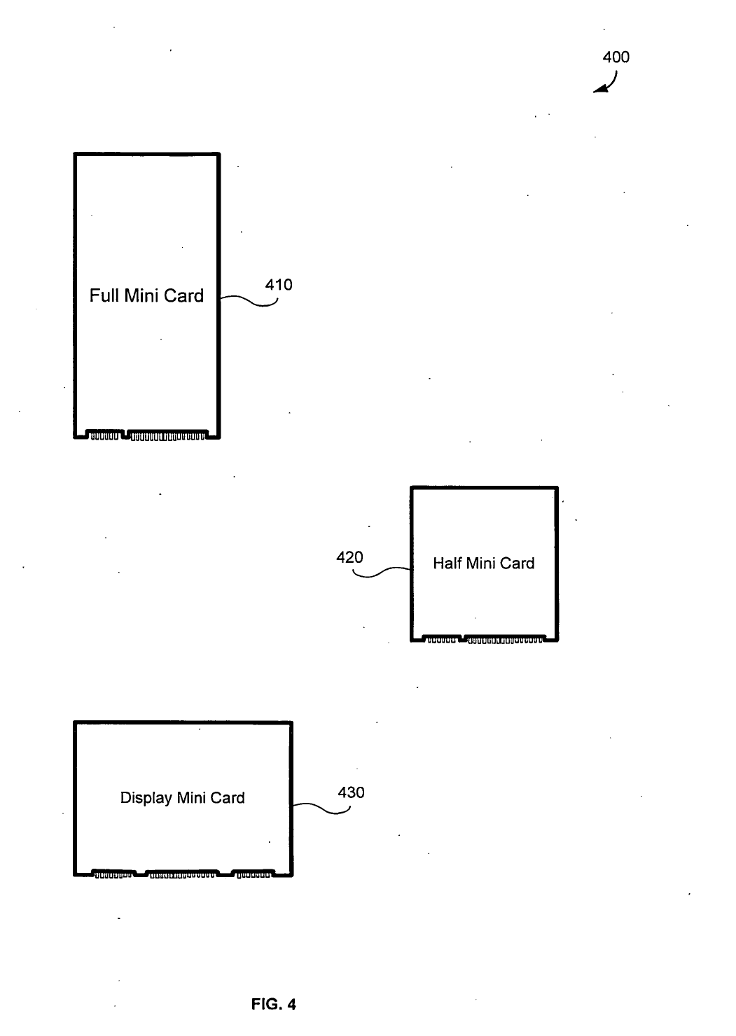

Now turning to FIG. 4, there is shown an exemplary schematic (400) of three types of PCI-Express mini cards.

There are several standards of PCI Express cards and connectors. One type of card may be a small form factor PCI Express card (PCI Express Full Mini Card—FMC 410). Another type of card may be a half size small form factor PCI Express card (PCI Express Half Mini Card—HMC 420). Another type of card may be the half size small form factor card with the addition of a Display Port (PCI Express Display Mini Card—DMC 430). The DMC (430) may be a bit larger than the PCI Express Half Mini Card (420) due to the addition of the Display Port pins (e.g. 24), while remaining smaller than the PCI Express Full Mini Card (410). According to some embodiments of the present invention, there may be a DMC system Connector into which the DMC (430) may be plugged.

The PCI Express Half Mini Card (420) may be approximately half the height of the PCI Express Full Mini Card (410) and may have the same width as the PCI Express Full Mini Card (410). The DMC (430) may be approximately the same height as the PCI Express Half Mini Card (420) but a bit wider to accommodate the additional (e.g. 24) Display Port pins.

According to some embodiments of the present invention, the Full Mini Card (410), the Half Mini Card (420), and/or the DMC (430) may plug into a Mini Card System Connector located on a laptop computer or any other device mother board.

According to some embodiments of the present invention, a video and/or audio signal source device may include a limited number of Display Mini Card (DMC) System Connectors. According to some embodiments of the present invention, the video and/or audio signal source device may include a limited number of Mini Card (HMC or FMC) System Connectors and a Display Port (DP) connector.

According to some embodiments of the present invention, the source device may have one or more antennas. According to some embodiments of the present invention the source device may have a limited number of antennas. According to some embodiments of the present invention, the antennas in the source device may be of different kinds and/or adapted for different frequencies.

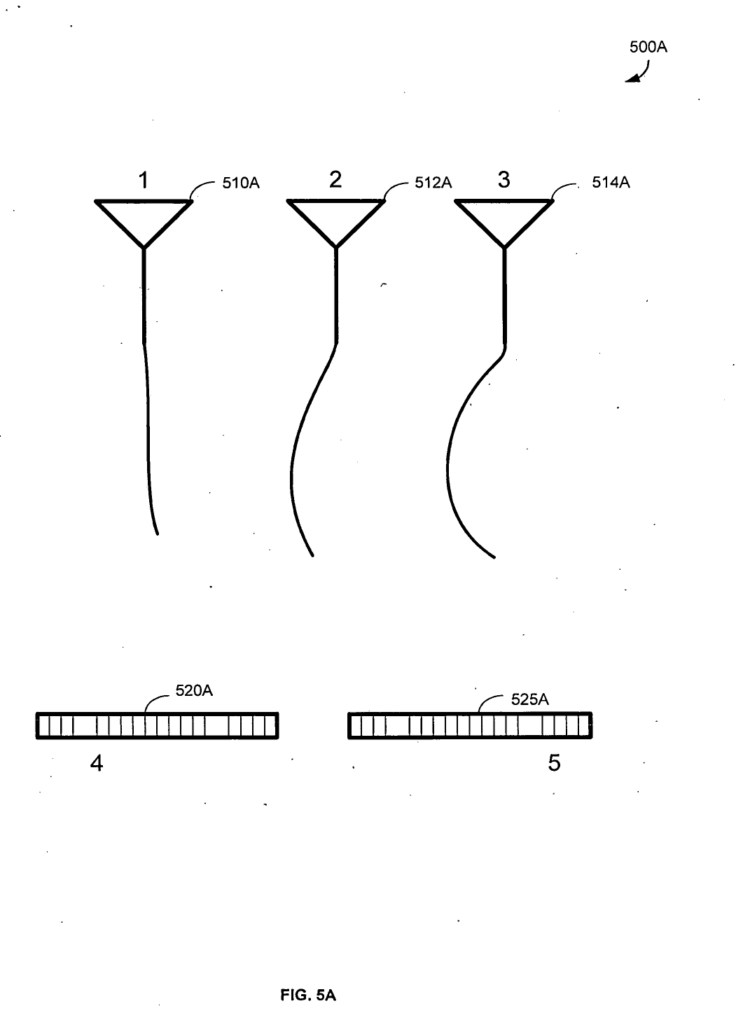

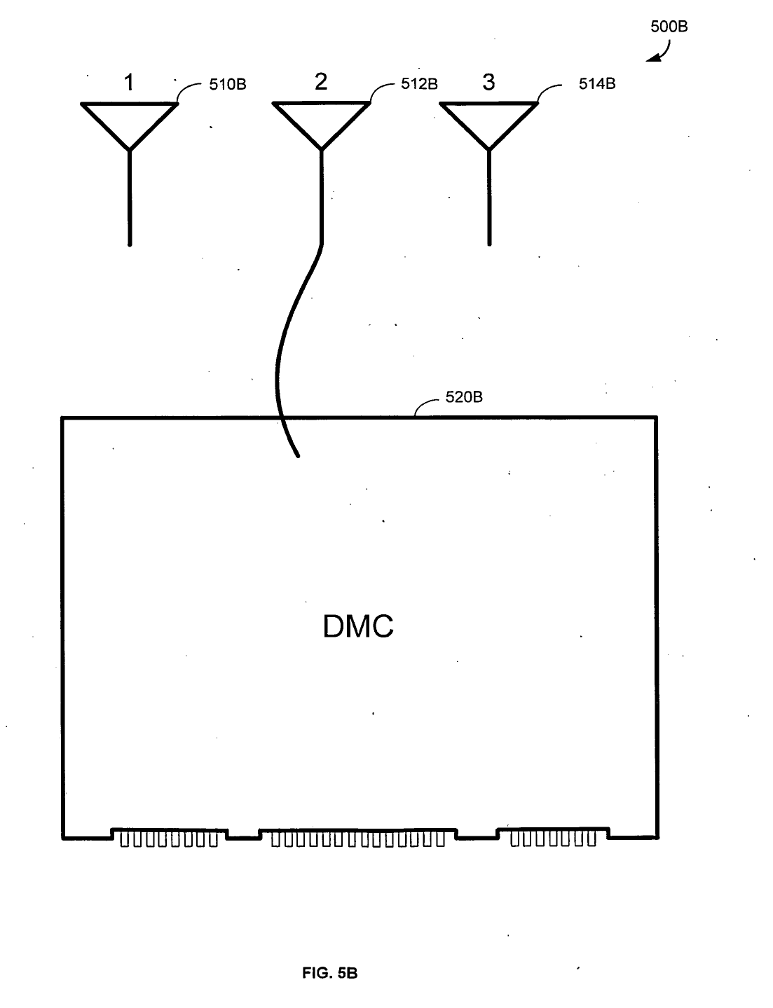

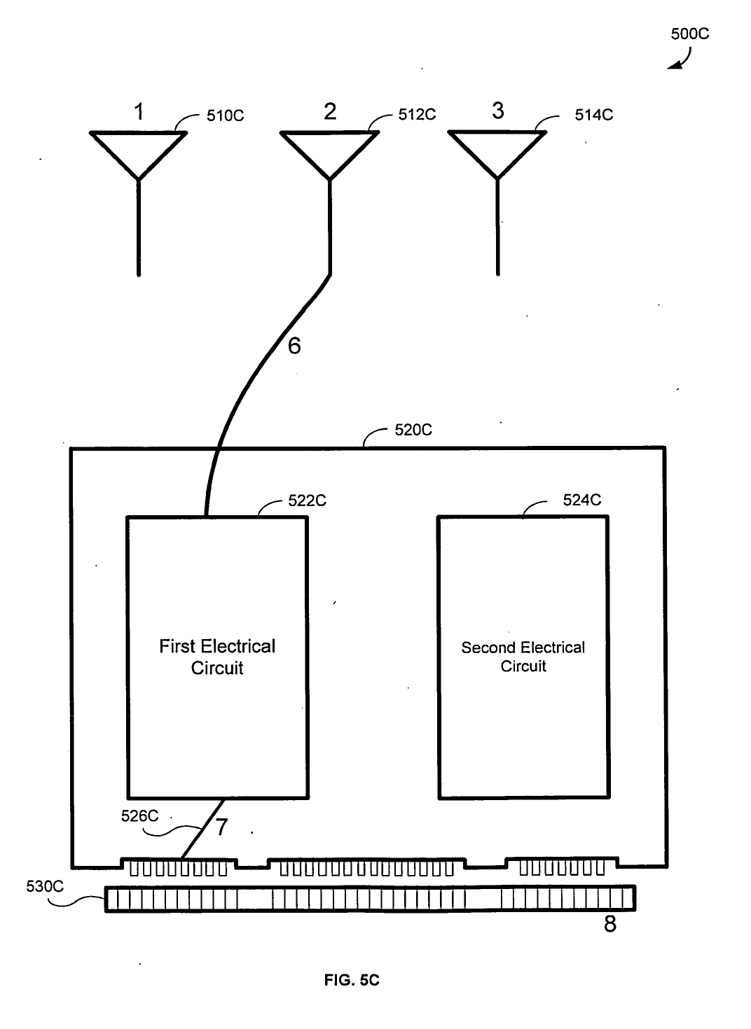

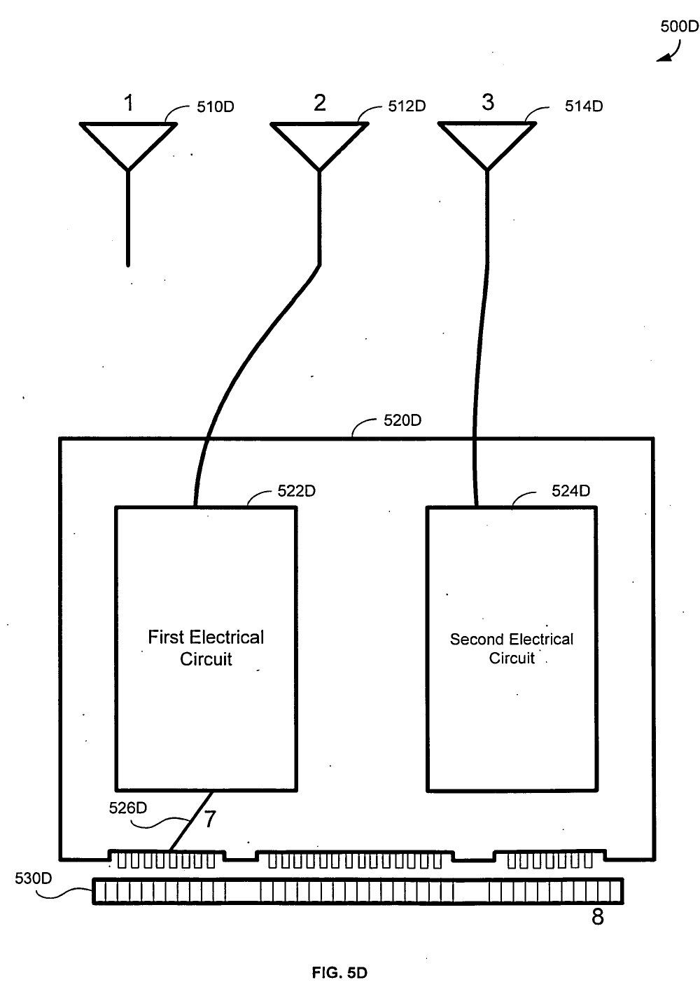

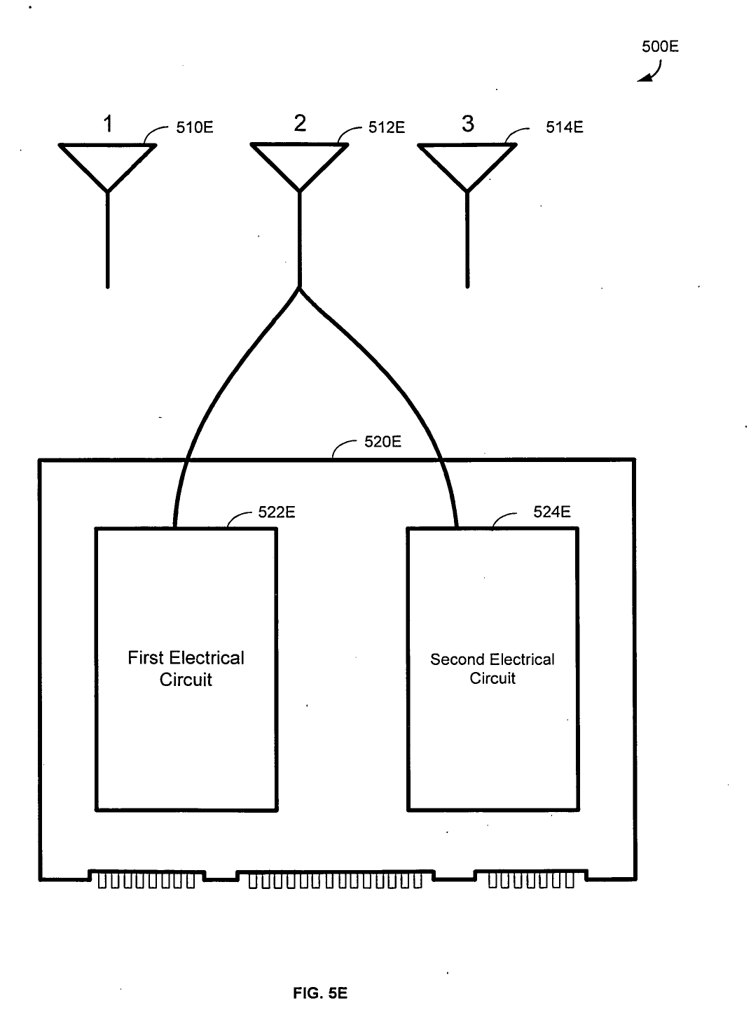

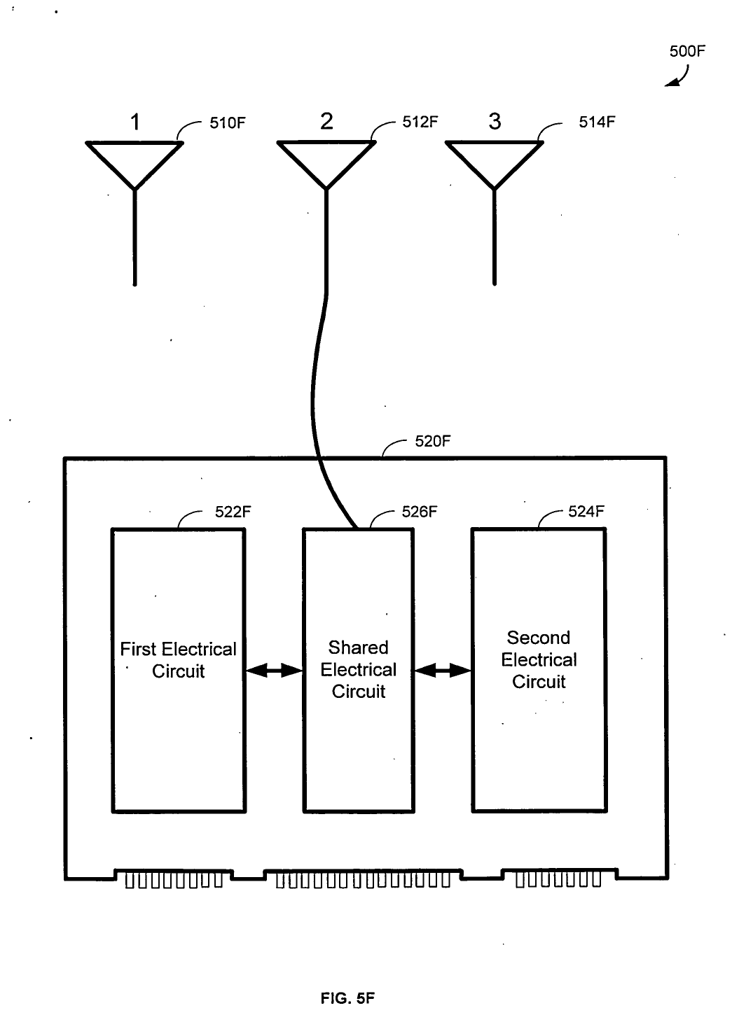

Now turning to FIG. 5A, there is shown an exemplary schematic (500A) of antennas (510A, 512A and 514A) and DMC system connectors (520A and 525A) for a laptop computer, according to some embodiments of the present invention.

Now turning to FIG. 5B, there is shown an exemplary schematic (500B) of a DMC (520B) connected to one antenna (512B), according to some embodiments of the present invention.

According to some embodiments of the present invention, there may be a Display Mini Card (DMC), a Half Mini Card (HMC) or a Full Mini Card (FMC) with a first electrical circuitry for transmitting the video and/or audio signals via one or more antenna connected to the Display Mini Card, the Half Mini Card (HMC) or the Full Mini Card (FMC). The one or more antenna may be located on the Display Mini Card (DMC), the Half Mini Card (HMC) or the Full Mini Card (FMC) (e.g. a chip antenna), and may additionally have a second electrical circuitry for performing other (e.g. Wi-Fi, LAN) functionality.

According to some embodiments of the present invention, a source device may require functionality such as Wi-Fi in addition to video. According to some embodiments of the present invention, there may be a Full Mini Card, Half Mini Card or Display Mini Card (DMC) with a second electrical circuitry adapted to perform the additional functionality. According to some embodiments of the present invention, the Display Mini Card (DMC), the Half Mini Card (HMC) or the Full Mini Card (FMC) may be connected to one or more additional antenna functionally associated with the second electrical circuitry performing the additional functionality. According to some embodiments of the present invention, the Display Mini Card, the Half Mini Card (HMC) or the Full Mini Card (FMC) may include an antenna (e.g. a chip antenna) functionally associated with the second electrical circuitry performing the additional functionality.

According to some embodiments of the present invention, the first electrical circuit adapted to transmit the video and/or audio signal and the second electrical circuit adapted to perform the additional functionality may be on a single Display Mini Card (DMC), a Half Mini Card (HMC) or a Full Mini Card (FMC). This may be advantageous since the number of DMC System Connectors and/or Mini-Card System Connectors in the source device may be limited and/or equal to or smaller than the number of additional functionalities required by the source device. Having the first and second electrical circuits on the same card may save space, power and cost. For example, printed circuit board (PCB) cost and space of two cards may be reduced to the cost and space of one PCB, the cost of two connectors may be reduced to the cost of one connector and the cost of two power circuits may be reduced to the cost of one power circuit.

Now turning to FIG. 5C, there is shown an exemplary schematic (500C) of a DMC (520C) plugged into a laptop's DMC system connector (530C), according to some embodiments of the present invention. The DMC (520C) includes a first electrical circuit (522C) connected to one antenna (512C) and further includes a second electrical circuit (524C).

According to some embodiments of the present invention, a first electrical circuit (522C) may receive a video signal from the DisplayPort pins of the DMC System Connector (530C) through electrical leads (526C). According to further embodiments of the present invention, the first electrical circuit (522C) may send a video signal to an antenna (512C) for transmission. The second electrical circuit may perform additional functionality e.g. Local Area Network (LAN) connectivity.

Now turning to FIG. 5D, there is shown an exemplary schematic (500D) of a DMC (520D) plugged into a laptop's DMC system connector (530D), according to some embodiments of the present invention. The DMC (520D) includes a first electrical circuit (522D) connected to one antenna (512D) and further includes a second electrical circuit (524D) connected to a second antenna (514D).

According to some embodiments of the present invention, a Display Mini Card (DMC 520D) may include a first electrical circuit adapted for receiving a video signal from the DisplayPort pins of the DMC System Connector (530D) through electrical leads (526D), and sending a video signal to one or more antenna (512D) for transmission. The DMC (520D) may further include a second electrical circuit (524D) performing additional wireless functionality (e.g. Wi-Fi) and sending a data signal to one or more antenna (514D) for transmission.

According to some embodiments of the present invention, the first and second electrical circuits may be connected to the same one or more antenna which may be connected to the DMC or located on the DMC. This may be advantageous since the number of antennas in the source device may be limited due to lack of space and/or the high cost of the antennas. Another advantage of having the first and second electrical circuits on the same Display Mini Card, the same Half Mini Card (HMC) or the same Full Mini Card (FMC) is the ability to connect the first electrical circuit performing video transmission and the second electrical circuit performing the additional functionality to the same antenna.

Now turning to FIG. 5E, there is shown an exemplary schematic (500E) of a DMC (520E) including first (522E) and second (524E) electrical circuits connected to one antenna (512E), according to some embodiments of the present invention.

According to some embodiments of the present invention, a DMC (520E) may include a first circuit adapted for transmitting a video signal (522E) and a second circuit adapted for transmitting a data signal (524E). The first and second circuits may be connected to the same antenna (512E).

According to some embodiments of the present invention, there may be a Display Mini Card (DMC), a Half Mini Card (HMC) or a Full Mini Card (FMC) including a first electrical circuitry adapted for transmitting the video and/or audio signals (522E) and including a second electrical circuitry adapted for performing additional (e.g. Wi-Fi) functionality. According to some embodiments of the present invention, there may be an electrical circuit that may be shared by the first and the second electrical circuits. According to some embodiments of the present invention, the first and second electrical circuits may be implemented in a single chip. According to some embodiments of the present invention, the first and second electrical circuits may share the same components, e.g. RFIC and/or RF amplifier.

Now turning to FIG. 5F, there is shown an exemplary schematic (500F) of a DMC (520F) including first (522F) and second (524F) electrical circuits having an additional shared electrical circuit (526F) connected to one antenna (512F), according to some embodiments of the present invention.

According to some embodiments of the present invention, the shared electrical circuit (526F) may receive a video signal from the first electrical circuit (522F) and a data signal from the second electrical circuit (524F). The shared electrical circuit (526F) may perform Time Domain Multiplexing (TDM) on the received signals, modulate the signals, amplify the signals and send the signals to one or more antenna (512F) for transmission.

According to some embodiments of the present invention, the first electrical circuit (522F) and the second electrical circuit (524F) may share the same wireless channel. According to some embodiments of the present invention, the wireless channel may be shared by Time Domain Multiplexing (TDM) in such a way that the first circuit may transmit in certain time periods over the wireless channel while the second circuit is not transmitting, and the second circuit may transmit in other time periods over the same wireless channel while the first circuit is not transmitting.

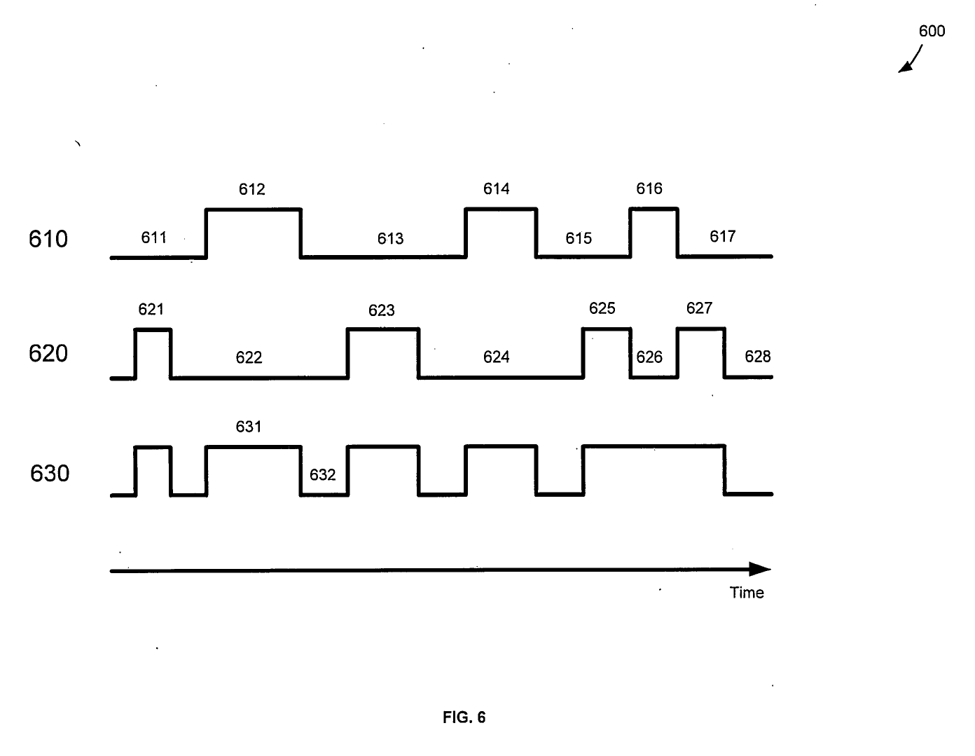

Now turning to FIG. 6, there is shown an exemplary diagram of time domain multiplexing (TDM) of two transmitting circuits (600), according to some embodiments of the present invention.

According to some embodiments of the present invention, TDM may be performed for the first and second circuits when using the same wireless channel. Line 610 describes a group of points in time (612, 614 and 616) in which the first circuit is using the channel and transmitting, and a group of points in time (611, 613, 615 and 617) in which the first circuit is not transmitting. Similarly, the second circuit is transmitting during periods 621, 623, 625 and 627, and not transmitting during periods 622, 624, 626 and 628 described by line 620. Line 630 describes the time periods in which the channel is busy (i.e. being used by either the first circuit or the second circuit) e.g. as shown in period 631, and the time periods in which the channel is idle e.g. as shown in period 632.

According to some embodiments of the present invention, when the first electrical circuit and the second electrical circuit are adapted to share the same channel in TDM, the first and second electrical circuits may share a single Radio Frequency (RF) circuitry. According to some embodiments of the present invention, the first circuit may be adapted to transmit at a first frequency, the second circuit may be adapted to transmit at a second frequency and they may transmit at the same time.

According to some embodiments of the present invention, the electrical circuitry adapted for transmitting video and/or audio signals may include electrical circuits for buffering a transmitted frame in a video frame buffer. The electrical circuitry may include circuits for comparing the current frame with a previous frame in a power saving architecture. According to further embodiments of the present invention, a frame may be transmitted if the difference between the current frame and a previous frame exceeds a threshold. According to some embodiments of the present invention, if the difference between the current frame and a previous frame is below a threshold, one or more circuits may be shut down and/or put into a sleep-mode or a standby-mode.

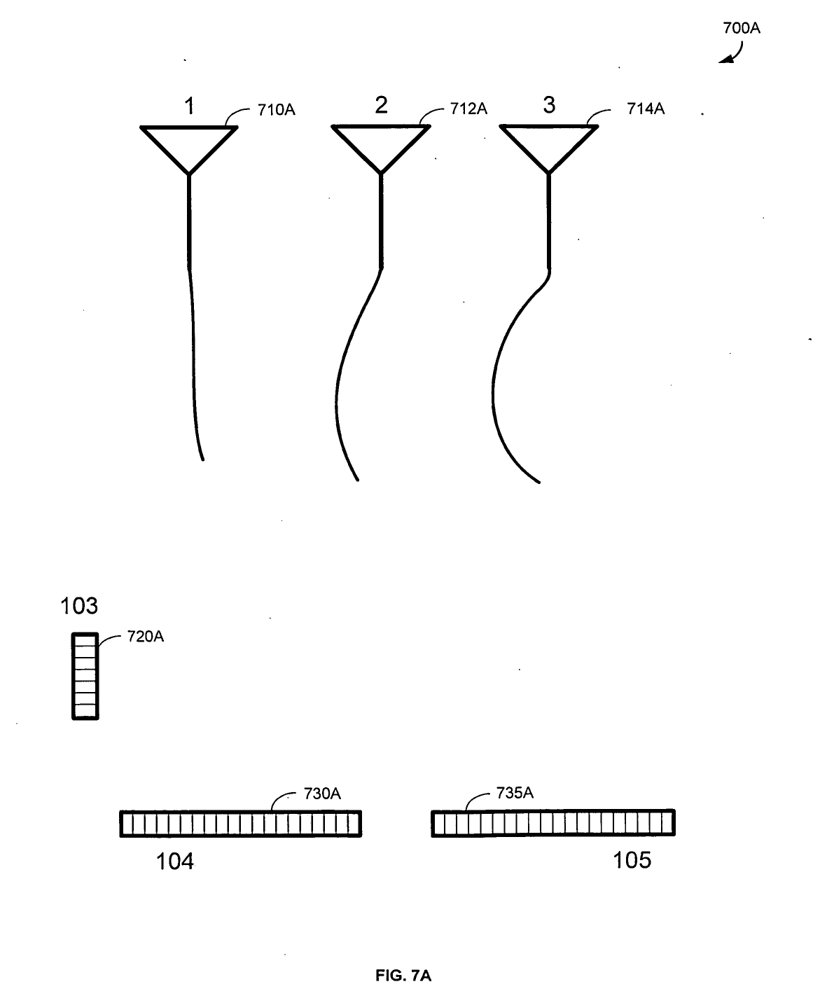

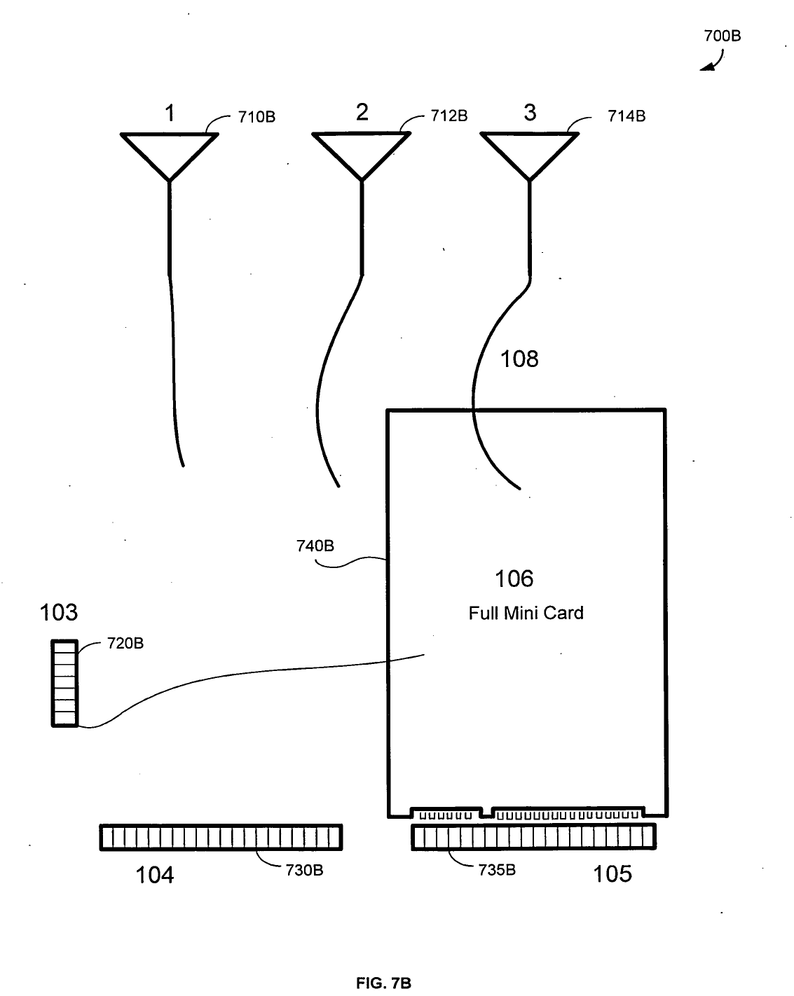

Now turning to FIG. 7A, there is shown an exemplary schematic of antennas (710A, 712A and 714A), DMC system connectors (730A and 735A) and a Display Port connector (720A) for a source device (e.g. laptop computer), according to some embodiments of the present invention.

According to some embodiments of the present invention, there may be a Display Mini Card (DMC) which may have a first electrical circuitry adapted to transmit video and/or audio signals. According to some embodiments of the present invention, the DMC may plug into a DMC System Connector of the source device. According to some embodiments of the present invention, the first electrical circuitry of the DMC may receive video and/or audio signals from the source device's Display Mini Card DMC System Connector.

According to some embodiments of the present invention, there may be a Mini Card (FMC or HMC) which may have a first electrical circuitry adapted to transmit video and/or audio signals. According to some embodiments of the present invention, the Mini Card (FMC or HMC) may plug into a Mini Card (MC) System Connector of a source device. According to some embodiments of the present invention, the Mini Card (HMC or FMC) may connect to the Display Port (DP) by connecting electrical cords. According to some embodiments of the present invention, the first electrical circuitry of the Mini Card (HMC or FMC) may receive video and/or audio signals from the source device's Display Port (DP) Connector through the connecting electrical cords. According to some embodiments of the present invention, the first electrical circuitry of the Display Mini Card (DMC) or the Half Mini Card (HMC) or the Full Mini Card (FMC) adapted to transmit the audio and/or video signal may be connected to one or more of the source device's antennas (710A, 712A and 714A).

Now turning to FIG. 7B, there is shown an exemplary schematic of antennas (710B, 712B and 714B), DMC system connectors (730B and 735B) and a Display Port connector (720B) for a source device (e.g. laptop computer), according to some embodiments of the present invention. A full mini card (740B) is attached to a DMC system connector (735B), a Display Port connector (720B) and one antenna (714B).

According to some embodiments of the present invention, a first electrical circuitry of the Display Mini Card (DMC), the Half Mini Card (HMC) or the Full Mini Card (FMC) may send the video and/or audio signals to a functionally associated one or more antenna for transmission. According to some embodiments of the present invention, the Display Mini Card (DMC), the Half Mini Card (HMC) or the Full Mini Card (FMC) may include one or more antenna e.g. a chip antenna or an antenna printed on the Display Mini Card printed circuit board (PCB). According to some embodiments of the present invention, the first electrical circuitry of the Display Mini Card (DMC), the Half Mini Card (HMC) or the Full Mini Card (FMC) may send video and/or audio signals to the one or more antenna included in the Display Mini Card, the Half Mini Card (HMC) or the Full Mini Card (FMC) for transmission. According to some embodiments of the present invention, the first electrical circuitry of the Display Mini Card (DMC), the Half Mini Card (HMC) or the Full Mini Card (FMC) may be adapted to transmit a video and/or audio signal using WHDI.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

It should be understood that the terms “transmission block”, “peripheral” and/or any other functional term may be implemented on, or composed of, one or more a interconnected integrated circuits on more or more semiconductor dies.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A peripheral comprising:
a first bus interface adapted to connect the peripheral to a first bus on a host device;
a second bus interface adapted to connect the peripheral to a second bus on a host device; and
wireless transceiver circuitry adapted to transmit data received by said peripheral over the first bus according to a first mode and to transmit data received by said peripheral over the second bus according to a second mode.

2. The peripheral according to claim 1, further comprising a control logic adapted to select a transmission mode from either the first transmission mode or the second transmission mode.

3. The peripheral according to claim 2, wherein said control logic is further adapted to select a transmission mode corresponding to data received over the busses.

4. The peripheral according to claim 1, further comprising a switching circuit adapted to switch between receiving data over the first bus when in the first transmission mode or over the second bus when in the second transmission mode.

5. The peripheral according to claim 1, wherein the first or the second transmission mode is a WHDI transmission mode.

6. A computing and communications device comprising:
a central processing unit (CPU) adapted to generate data network based data, and further adapted to transmit the data along a first bus;
a graphics processing unit (GPU) adapted to generate video data, and further adapted to transmit the data along a second bus;
a peripheral comprising: a first bus interface adapted to connect the peripheral to the first bus; a second bus interface adapted to connect the peripheral to the second bus;
and wireless transceiver circuitry adapted to transmit data network based data received by said peripheral over the first bus according to a first mode and to transmit video data received by said peripheral over the second bus according to a second mode.

7. The computing and communications device according to claim 6, further comprising a control logic adapted to select a transmission mode from either the first transmission mode or the second transmission mode.

8. The computing and communications device according to claim 7, wherein said control logic is further adapted to select a transmission mode corresponding to data received over the busses.

9. The computing and communications device according to claim 6, further comprising a switching circuit adapted to switch between receiving data over the first bus when in the first transmission mode or over the second bus when in the second transmission mode.

10. The computing and communications device according to claim 6, wherein the video data is transmitted in a WHDI transmission mode.

11. A data transmission method comprising: connecting to a first bus on a host device;
transmitting data received over the first bus according to a first mode; connecting to a second bus on a host device; and transmitting data received over the second bus according to a second mode.

12. The method according to claim 11, further comprising selecting a transmission mode from either the first transmission mode or the second transmission mode.

13. The method according to claim 12, further comprising selecting a transmission mode corresponding to data received over the busses.

14. The method according to claim 11, further comprising switching between receiving data over the first bus when in the first transmission mode or over the second bus when in the second transmission mode.

15. The method according to claim 11, wherein a first or second transmission mode is a WHDI transmission mode.
